(19) United States
(12) Patent Application Publication
(10) Pub. No.: US 2009/0279814 A1
(43) Pub. Date: Nov. 12, 2009

(54) LINEAR BEARING

(76) Inventor: YI-CHANG YANG, Taichung City (TW)

Correspondence Address: PHILLIP LIU, 6980, WHITEOAK DRIVE, RICHMOND, BC, V7E 4Z9, CA

(21) Appl. No.: 12/433,781

(22) Filed: Apr. 30, 2009

(30) Foreign Application Priority Data
May 6, 2008 (TW) 097116583

(51) Int. Cl. F16C 29/06; F16C 19/00

(52) U.S. Cl. 384/44; 384/50

(57) ABSTRACT

A linear bearing includes a casing which has multiple slots defined axially through a wall thereof and rollers are engaged with the slots. Two grooves are radially defined in the outer surface of the casing and located close to two ends of the casing. The grooves communicate with the slots. Two collars are engaged with the grooves so as to prevent the rollers from disengaging from the slots. Each slot includes guide grooves defined in two insides thereof so that the two axles on two ends of each roller are engaged with the guide grooves.

### FIELD OF THE INVENTION

The present invention relates to a linear bearing and more particularly, to a linear bearing with reliable rollers to avoid the linear bearing from swing or shaking during use.

### BACKGROUND OF THE INVENTION

A conventional linear bearing is used with a guide rod 40 ensure that the molds move linearly. The linear bearing includes multiple rollers and each roller contacts the guide rod in point-to-point manner which reduces the friction between the rollers and the guide rod and between the linear bearing and the molds significantly. The linear bearing moves at high speed between the guide rod and the molds, such that there will be wearing between the moving parts and the wearing causes swing or shaking of the guide rod and the molds. Therefore, the operation of the guide rod and the molds becomes unstable and cannot have precise movement as expected. The abnormal swing and shaking reduce precision of the molds.

The present invention intends to provide a linear bearing wherein the rollers are well positioned so that the contact surfaces of the rollers evenly contact the molds and the guide rod.

### SUMMARY OF THE INVENTION

The present invention relates to a roller of linear bearing and the roller comprises a cylindrical portion having a contact area defined in an outer periphery thereof and two axles extend from two ends of the cylindrical portion. The rollers are engaged with slots in the casing of the linear bearing and the two axles are engaged with guide grooves defined in two insides of each slot.

The primary object of the present invention is to provide a linear bearing and the rollers used in the linear bearing, wherein the rollers are operated smoothly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the roller of the present invention;

FIG. 2 is a cross sectional view of the roller of the present invention;

FIG. 3 is an exploded view to show the linear bearing of the present invention;

FIG. 4 is a perspective view to show the linear bearing of the present invention;

FIG. 4A is a cross sectional view taken along line A-A in FIG. 4;

FIG. 5 is an enlarged cross sectional view of one of the rollers in the linear bearing of the present invention;

FIG. 6 is a partial cross sectional view to show the linear bearing cooperated with the guide rod and the mold;

FIG. 7 is an exploded view to show another embodiment of the roller of the present invention;

FIG. 8 is a partial cross sectional view of the roller in FIG. 7;

FIG. 9 shows another embodiment of the linear bearing of the present invention;

FIG. 10 is an enlarged cross sectional view to show that the roller of the linear bearing contacts the mold and the guide rod;

FIG. 11 is an exploded view to show yet another embodiment of the linear bearing of the present invention;

FIG. 12 shows the arrangement of the rollers in the circular grooves in the linear bearing in FIG. 11;

FIG. 13 is a cross sectional view of the linear bearing in FIG. 11, and

FIG. 14 shows the linear bearing of FIG. 11 contacts the casing and the guide rod.

### DETAILED DESCRIPTION OF THE PREFERRED EMBODIMENT

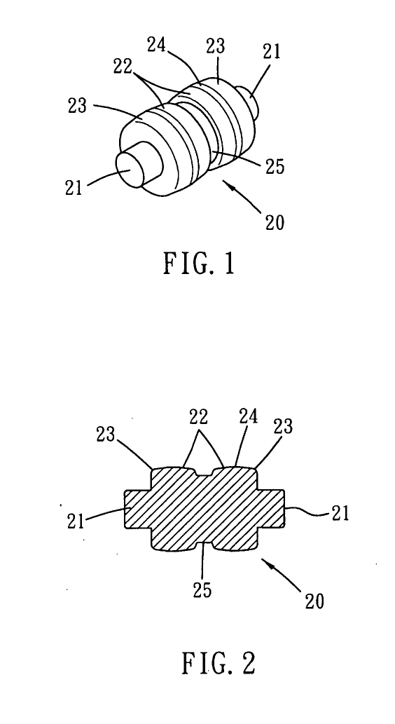

Referring to FIGS. 1 to 3, the rollers 20 and the linear bearing 1 are disclosed and each of the rollers 20 includes a cylindrical portion having a contact area defined in an outer periphery thereof. Two axles 21 extend from two ends of the cylindrical portion and are integral with the cylindrical portion in this embodiment. The two axles 21 are engaged with guide grooves 12 in a casing 10 of the linear bearing 1. The contact area includes two convex portions and a central groove 25 is defined between the two convex portions. Each convex portion includes a first contact surface 22, a second contact surface 23 and a friction surface 24. The friction surface 24 is defined on an apex portion of the convex portion. The first contact surface 22 extends from the central groove 25 to a side of the friction surface 24 corresponding thereto and the second contact surface 23 extends from the central groove 25 to the other side of the friction surface 24 corresponding thereto.

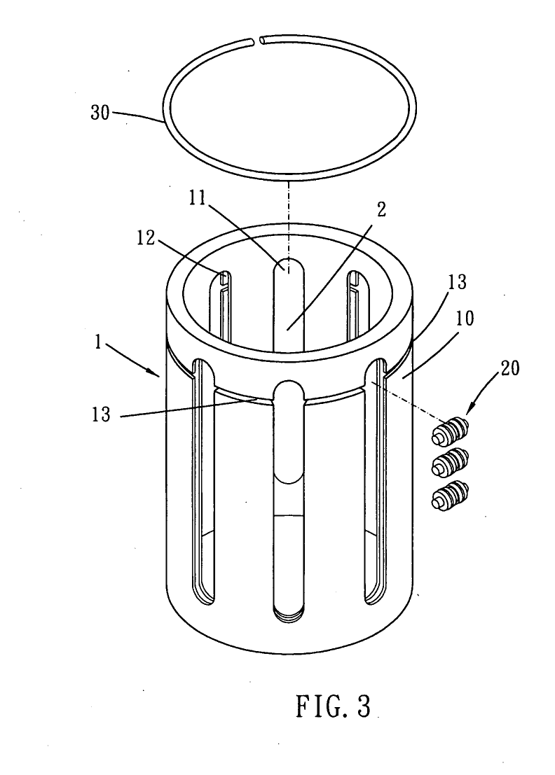

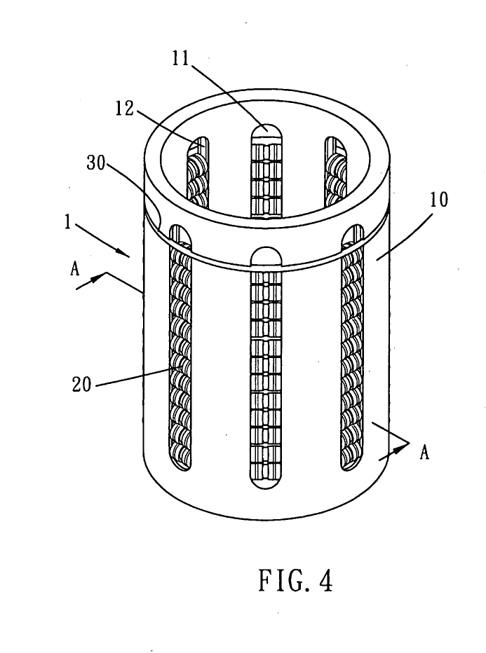

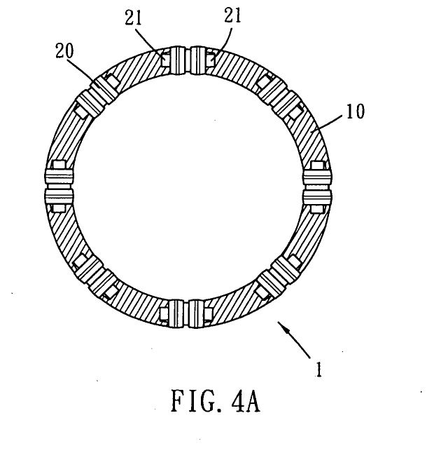

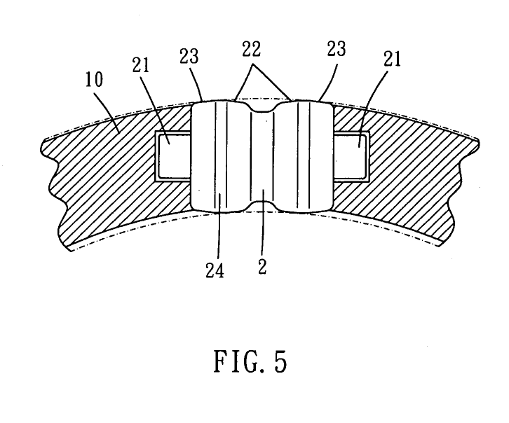

Further referring to FIGS. 3, 4, 4A, 5 and 6, the linear bearing 1 includes a casing 10 which is a hollow cylindrical casing and a plurality of slots 11 are defined axially through a wall of the casing 10. The two guide grooves 12 are defined in two insides of each of the slots 11. The rollers 20 are engaged with the slots 11 and the two axles 21 of the rollers 20 are engaged with the guide grooves 12. A first groove 13 is radially defined in an outer surface of a first end of the casing 10 and communicates with the slots 11. A first collar 30 is engaged with the first groove 13 so as to prevent the rollers 20 from disengaging from the slots 11. The axis that each of the rollers 20 spins about is perpendicular to an axis of the casing 10 such that the rollers 20 spin smoothly in a stable status.

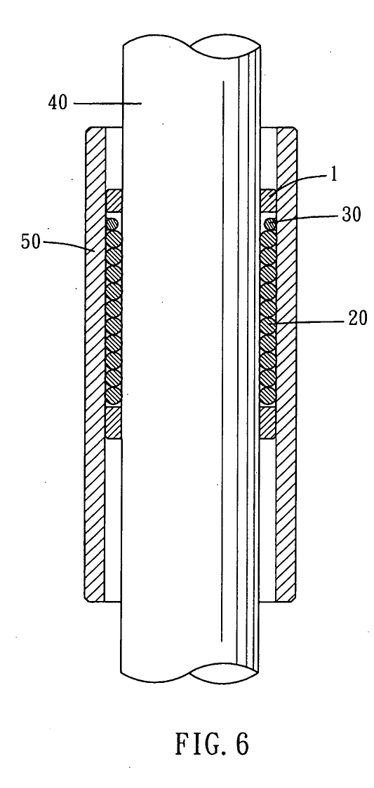

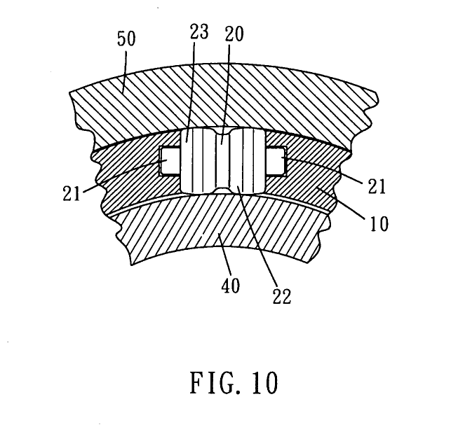

Referring to FIG. 10, the linear bearing 1 is located between a guide rod 40 and a mold 50 as shown in FIG. 6, the first contact surfaces 22 of the rollers 20 contact the outside of the guide rod 40 and the second contact surfaces 23 of the rollers 20 contact the inside of the mold 50. The guide rod 40 and the mold 50 are smoothly moved linearly by using the linear bearing 1 of the present invention. The first and second contact surfaces 22, 23 evenly share the stress and friction so that the rollers 20 have longer life.

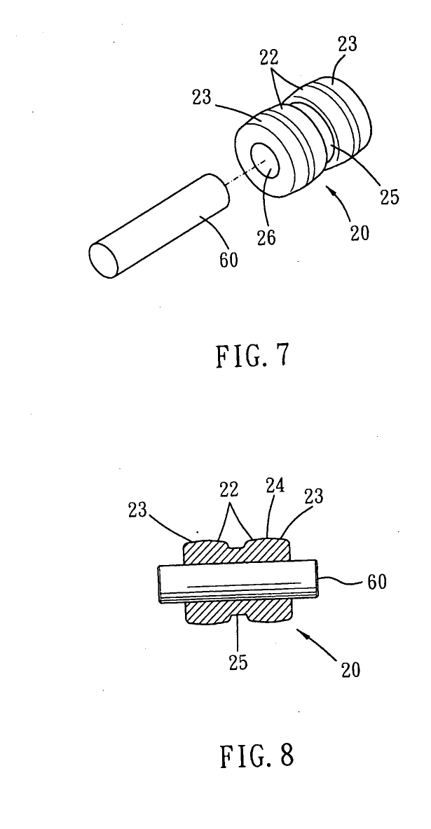

As shown in FIGS. 7 and 8, the cylindrical portion of each roller 20 may have a passage 26 defined axially therethrough and a shaft 60 extends through the passage 26. Two ends of the shaft 60 protrude from the two ends of the cylindrical portion.

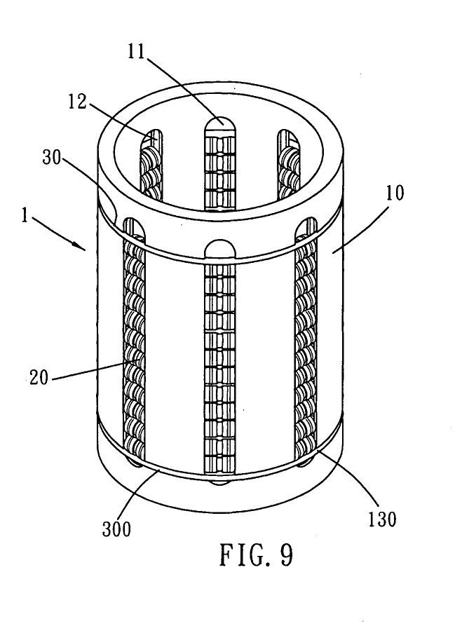

FIG. 9 shows that the casing 10 may further includes a second groove 130 radially defined in the outer surface of a second end thereof and the second groove 130 communicates with the slots 11. A second collar 300 is engaged with the second groove 130 to prevent the rollers 20 from disengaging from the slots 1.

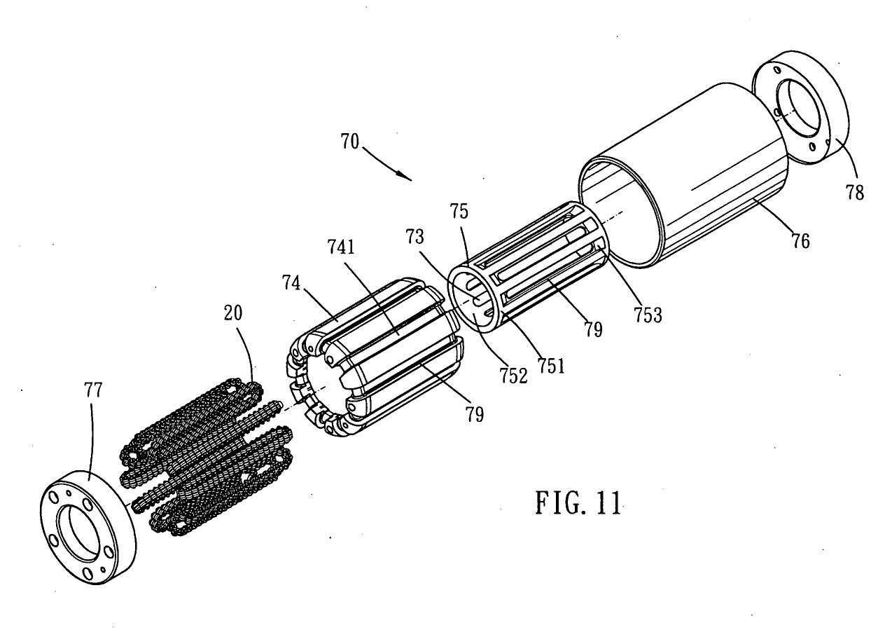

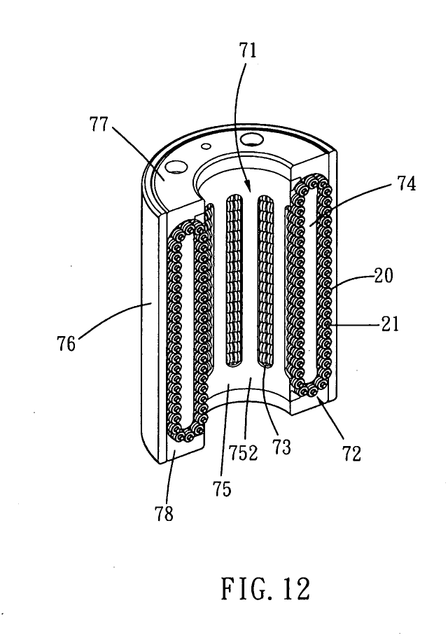

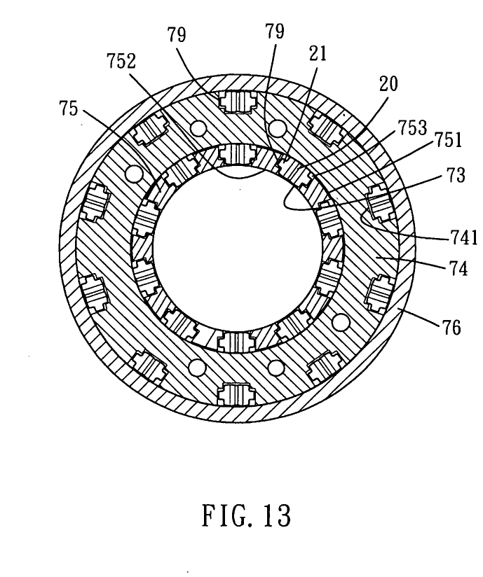

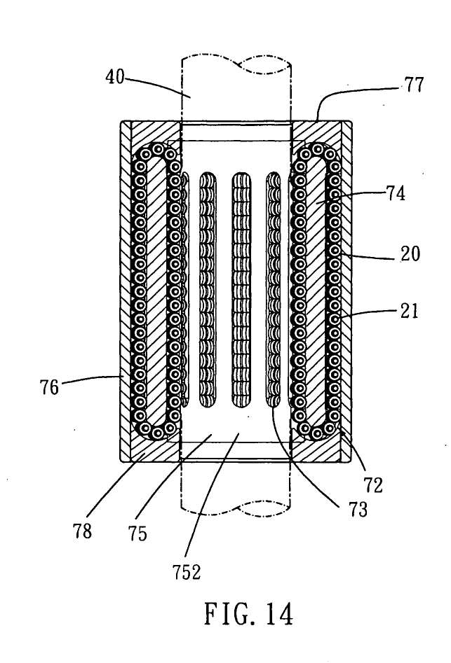

FIGS. 11 to 14 show another embodiment of the linear bearing 70 which comprises a central passage 71 defined axially therethrough and a plurality of circular grooves 72 are defined in the linear bearing 70. The circular grooves 72 are located in radial directions in the linear bearing 70 and communicate with the central passage 71. Multiple axial slots 73 are defined in an inner periphery of the central passage 71 and communicate with the central passage 71 and the circular grooves 72. The rollers 20 are received in the circular grooves 72 and the rollers 20 spin and move along the circular grooves 72. An axis that each of the rollers 20 spins about is perpendicular to an axis of the central passage 71.

In detail, the linear bearing 70 includes an outer part 74, an inner part 75, a casing 76, a first cap 77 and a second cap 78. The outer part 74 is located between the inner pat 75 and the casing 76, and the first and second caps 77, 78 are connected to two ends of the outer part 74. The outer part 74 includes multiple first spaces 741 defined radially and axially in an outer surface thereof which faces an inner surface of the casing 76. The inner part 75 includes an outer surface 751 and an inner surface 752, the outer surface 751 faces the outer part 74 and the inner surface 752 is located remote from the outer part 74. Multiple second spaces 753 are defined in the outer surface 751 and located corresponding to the first spaces 741. The axial slots 73 are defined in the inner surface 752 and communicate with the second spaces 753 correspondingly. The first and second spaces 741, 753 define the circular grooves 72. Each of the first and second spaces 741, 753 includes two guide grooves 79 defined in two insides thereof and the axles 21 of the rollers 20 are engaged with the guide grooves 79.

When the linear bearing 70 moves relative to the guide rod 40, the rollers 20 spin about the axles 21 and move along the circular grooves 72. The direction that the rollers 20 move in the axial slots 73 is opposite to the direction that the linear bearing 70 moves relative to the guide rod 40. Therefore, the rollers 20 are partially in contact with the guide rod 40, preferably, less than 50% of the number of the rollers 20 are in contact with the guide rod 40. This can make the rollers 20 to have double life time when compared with the rollers constantly contacting the guide rod. Besides, the rollers 20 are located in contact with each other so as to keep the axles 21 to be perpendicular to the axis of the central passage 71 and the rollers 20 can operate smoothly. The casing 76 can avoid dust or objects from entering the circular grooves 72 of the linear bearing.

While we have shown and described the embodiment in accordance with the present invention, it should be clear to those skilled in the art that further embodiments may be made without departing from the scope of the present invention.

What is claimed is:

1. A roller comprising:
a cylindrical portion having a contact area defined in an outer periphery thereof and two axles (21) extending from two ends of the cylindrical portion, the two axles (21) being adapted to be engaged with guide grooves (12) in a casing (10) of a linear bearing (1), the contact area including two convex portions and a central groove (25) defined between the two convex portions, each convex portion including a first contact surface (22), a second contact surface (23) and a friction surface (24), the friction surface (24) defined on an apex portion of each convex portion, the first contact surface (22) extending from the central groove (25) to a side of the friction surface (24) corresponding thereto, the second contact surface (23) extending from the central groove (25) to the other side of the friction surface (24) corresponding thereto.

2. The roller as claimed in claim 1, wherein the cylindrical portion includes a passage (26) defined axially therethrough and a shaft (60) extends through the passage (26), two ends of the shaft (60) protrude from the two ends of the cylindrical portion.

3. The roller as claimed in claim 1, wherein the two axles (21) are integral with the cylindrical portion.

4. A linear bearing comprising:
a casing (10) and multiple rollers (20) connected to the casing (10), each roller (20) including a cylindrical portion which has a contact area defined in an outer periphery thereof, two axles (21) extending from two ends of the cylindrical portion, the contact area including two convex portions and a central groove (25) defined between the two convex portions, each convex portion including a first contact surface (22), a second contact surface (23) and a friction surface (24), the friction surface (24) defined on an apex portion of each convex portion, the first contact surface (22) extending from the central groove (25) to a side of the friction surface (24) corresponding thereto, the second contact surface (23) extending from the central groove (25) to the other side of the friction surface (24) corresponding thereto.

5. The linear bearing as claimed in claim 4, wherein the casing (10) is a hollow cylindrical casing and a plurality of slots (11) are defined axially through a wall of the casing (10), two guide grooves (12) are defined in two insides of each of the slots (11), the rollers (20) are engaged with the slots (11) and two axles (21) of the rollers (20) are engaged with the guide grooves (12), a first groove (13) is radially defined in an outer surface of a first end of the casing (10) and communicates with the slots (11), a first collar (30) is engaged with the first groove (13).

6. The linear bearing as claimed in claim 5, wherein a second groove (130) is radially defined in the outer surface of a second end of the casing (10) and communicates with the slots (11), a second collar (300) is engaged with the second groove (130).

7. The linear bearing as claimed in claim 4, wherein the linear bearing (70) includes a central passage (71) defined axially therethrough and a plurality of circular grooves (72) are defined in the linear bearing (70), the circular grooves (72) are located in radial directions in the linear bearing (70) and communicate with the central passage (71), multiple axial slots (73) are defined in an inner periphery of the central passage (71) and communicate with the central passage (71) and the circular grooves (72), the rollers (20) are received in the circular grooves (72) and the rollers (20) spin and move along the circular grooves (72), an axis that each of the rollers (20) spins about is perpendicular to an axis of the central passage (71).

8. The linear bearing as claimed in claim 7, wherein the linear bearing (70) includes an outer part (74), an inner part (75), a casing (76), a first cap (77) and a second cap (78), the outer part (74) is located between the inner pat (75) and the casing (76), the first and second caps (77, 78) are connected to two ends of the outer part (74), the outer part (74) includes multiple first spaces (741) defined radially and axially in an outer surface thereof which faces an inner surface of the casing (76), the inner part (75) includes an outer surface (751) and an inner surface (752), the outer surface (751) faces the outer part (74) and the inner surface (752) is located remote from the outer part (74), multiple second spaces (753) are defined in the outer surface (751) and located corresponding to the first spaces (741), the axial slots (73) are defined in the inner surface (752) and communicate with the second spaces (753) correspondingly, the first and second spaces (741, 753) define the circular grooves (72).

9. The linear bearing as claimed in claim 8, wherein each of the first and second spaces (741, 753) includes two guide grooves (79) defined in two insides thereof and the axles (21) of the rollers (20) are engaged with the guide grooves (79).
